(19) United States
(12) Patent Application Publication
(10) Pub. No.: US 2009/0012731 A1
(43) Pub. Date: Jan. 8, 2009

(54) METHOD AND DEVICE FOR CALIBRATION OF DIGITAL SUN SENSOR

(76) Inventors: Guangjun Zhang, Beijing (CN); Xinguo Wei, Beijing (CN); Qiaoyun Fan, Beijing (CN); Jie Jiang, Beijing (CN)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/019,539

(22) Filed: Jan. 24, 2008

(30) Foreign Application Priority Data
Jul. 6, 2007 (CN) 200710118498.1

(51) Int. Cl. G01C 25/00

(52) U.S. Cl. 702/85

(57) ABSTRACT

A method for calibration of a digital sun sensor is disclosed. The method comprises following steps. First, an integrated mathematic model for imaging of a sun sensor is established according to the external and internal parameters of the calibration system of the sun sensor. Next, the two axis of the rotator are rotated by different angles. Then, calibration points' data are acquired and sent to a processing computer through an interface circuit. Finally, a two-step calibration program is implemented to calculate the calibration parameters by substituting the calibration points' data to the integrated mathematic model. The disclosure also relates to an application device of the calibration method. The device comprises: a sun simulator to provide the incident sunlight, a two-axis rotator to acquire different the calibration points' data, and a processing computer to record the calibration points' data and calculate the calibration parameters. The calibration method and device apply to many kinds of digital sun sensors. By integrated external and internal parameters modeling, the disclosure improves calibration precision. Meanwhile, the whole calibration process is simplified because precise installation and adjustment is not required.

### CROSS-REFERENCE TO RELATED APPLICATIONS

This application claims priority from Chinese Patent Application Serial No. 200710118498.1 filed Jul. 6, 2007, the disclosure of which, including the specification, drawings and claims, is incorporated herein by reference in its entirety.

### TECHNICAL FIELD

The disclosure relates to the measurement techniques for a sun sensor, and more particularly to a kind of method and device for calibration of a digital sun sensor.

### BACKGROUND

A sun sensor is a kind of attitude sensor for measuring the angle between the sun light and a certain axis or plane of a moving vehicle. Sun sensors are widely used in many areas such as, for example, solar energy utilization and attitude control of spacecraft. New digital sun sensors mainly include: an optical mask with single pinhole or pinhole array, an image sensor such as a CMOS (Complementary Metal Oxide Semiconductor) or a CCD (Charge Coupled Device), and an information processing circuit. The principle of a sun sensor is as follows: the sun light is projected onto the image sensor though the pinhole on the optical mask and a spot is formed. The position of the spot changes with the incident angle of sun light. Then, spot image processing and attitude computing are executed by an information processing circuit. Finally, the attitude of spacecraft is obtained.

Before the sun sensor is put into use, the internal parameters of it must be precisely calibrated to guarantee high measurement precision. The internal parameters include the focal length F, which equals to distance between the optical mask and the image sensor, the origin coordinate where the pin hole is projected to the image sensor (also called as main point) and the distortion coefficients, etc. The calibration of such internal parameters is referred to as sun sensor calibration. Currently, there are two kinds of calibration methods. The first utilizes the real sunlight and performs data acquisition and calibration when the sun is at or near its zenith. The second uses sun simulators to provide sun light, perform data acquisition, and calibration with the help of rotator. For the latter, only focal length F and an origin coordinate are used in the calibration model, and the calibration precision is higher than the former. Moreover, the calibration process is more convenient. However, there are some disadvantages with this method:

The sunlight vector from the sun simulator is not strictly vertical to the plane formed by the two rotation axes of the rotator coordinate frame. Moreover, there is installation error between the sun sensor and the rotator, such that the sun sensor coordinate frame can not be identical to the rotator coordinate frame. Because of those external factors, such as installation error and adjustment error, there is error in the calibration method which uses only internal parameters in imaging modeling of a sun sensor. Therefore, the precision of estimation of internal parameters is adversely influenced.

Generally, the optical mask of a sun sensor is shaped by etching a pinhole on a glass base. Because of the refraction of glass base and the limitation of the processing technique, there is nonlinear distortion in the pinhole imaging model of a sun sensor. Accordingly, errors are introduced into the calibration method which only includes internal parameters of focal length F and origin coordinate.

### SUMMARY

To address the problems mentioned above, the disclosure aims at providing a high precision calibration method and device for a digital sun sensor.

To reach the aims above, the technical scheme of the invention is as follows.

A calibration method for a digital sun sensor is disclosed, which includes the following steps.

A. First, an integrated mathematic model for imaging of a sun sensor is established according to external and internal parameters of a calibration system of a sun sensor.

B. By rotating two axes of a rotator by different angles, calibration points' data is acquired and sent to a processing computer through an interface circuit.

C. A two-step calibration program is then implemented to calculate the calibration parameters after substituting calibration points' data to the integrated mathematic model.

In one embodiment of the disclosed method, Step A further comprises:

A1. Establishing a rotator coordinate frame and a sun sensor coordinate frame, and establishing an external parameters' modeling equation according to a rotation matrix from the rotator coordinate frame to the sun sensor coordinate frame and a pitch and yaw angle of simulated sun light in the rotator coordinate frame.

A2. Establishing an internal parameters' modeling equation, wherein the internal parameters include: the origin coordinate where a pin hole on an optical mask of a sun sensor is projected to an image sensor, a focal length which equals to a distance between the optical mask and the image sensor, and a radial and tangential distortion coefficient of the optical mask.

A3. Establishing an integrated external and internal parameters imaging modeling equation of the sun sensor according to the external parameters modeling equation and the internal parameters modeling equation of calibration system.

In one embodiment, Step C of the disclosed method further includes:

C1. Assuming that the radial and tangential distortion coefficients of internal parameters are zeros, the origin coordinate where the pin hole is projected to image sensor is determined by a nonlinear least square iteration.

C2. Based on the results from step C1, the rest of the parameters are calculated by a nonlinear least square iteration.

An embodiment of a calibration device for digital sun sensor comprises: a sun simulator to provide incident sun light, a two-axis rotator with internal and external frames, a bracket on which the sun sensor is installed, an optical platform to uphold the sun simulator and two-axis rotator, and a processing computer connected to the sun sensor to perform calibration data acquisition and processing. The sun simulator and two-axis rotator are installed on the each side of the optical platform respectively.

The processing computer, which comprises a data acquisition module and a data processing module, calculates calibration parameters by a data processing program.

The data acquisition module acquires the calibration points' data, which includes the rotating angle of internal frame of the two-axis rotator, the rotating angle of external frame of the two-axis rotator and the centroid coordinate of imaging spot at this position.

The data processing module calculates the final calibration parameters based on the calibration points' data acquired above.

The embodiments disclosed have following advantages:

An integrated external and internal parameters modeling is adopted in the disclosure, which avoids the introduction of the error of external parameters into the estimation process of internal parameters. Therefore, the calibration precision of the internal parameters is improved.

The calibration precision is improved by considering the distortion coefficients as a part of the internal parameters.

No complicated installation and adjustment is needed, so that the calibration process is simplified noticeably.

### BRIEF DESCRIPTION OF THE DRAWINGS

The accompanying drawings, which are incorporated in and constitute a part of specification, illustrate an exemplary embodiment of the present disclosure and, together with the general description given above and the detailed description of the embodiment given below, serve to explain the principles of the present disclosure.

FIG. 1 is a flow chart illustrating the method of the present embodiment;

FIG. 2 is a schematic diagram illustrating the distribution of the calibration points on the image sensor;

FIG. 3 is a schematic diagram showing a structure of the calibration device of the present disclosure.

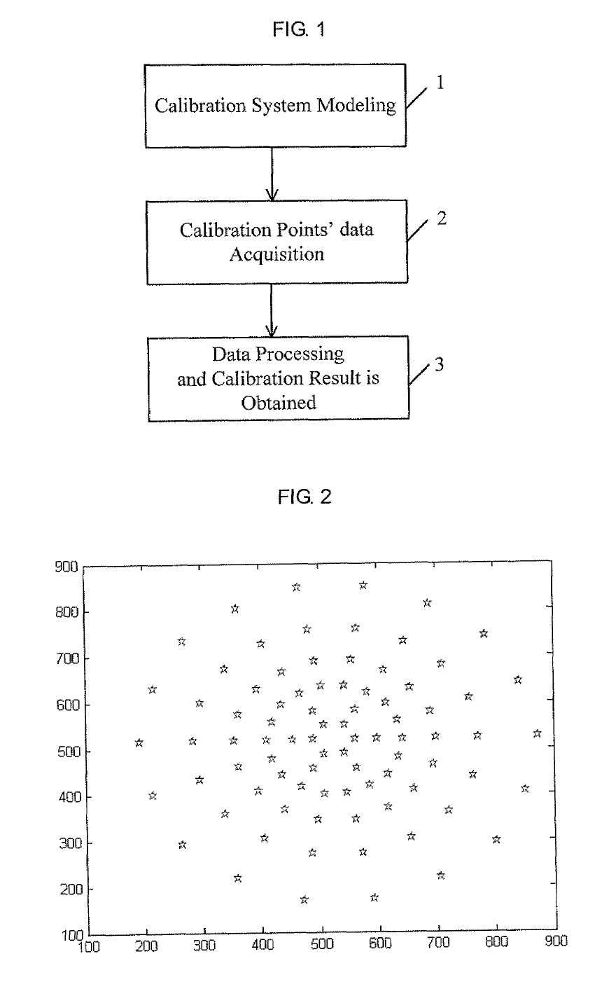

### DETAILED DESCRIPTION

While the claims are not limited to the illustrated embodiments, an appreciation of various aspects of the present disclosure is best gained through a discussion of various examples thereof. Referring now to the drawings, illustrative embodiments will be described in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

The basic principle of the disclosure is establishing an integrated external and internal parameters imaging modeling of sun sensor, which takes into account the errors such as the installation error of sun simulator, the installation error of sun sensor on the two-axis rotator, the installation error of optical mask and the distortion of optical mask, etc; a two-step calibration method is implemented to solve the parameters and high precision of calibration is achieved.

The disclosure uses an integrated external and internal parameters modeling method to establish the mathematic imaging model of a sun sensor. The detailed steps are as follows.

Step 1: The integrated imaging model of sun sensor is established according to the external and internal parameters of the calibration system of a sun sensor,

Step 101: Coordinate frames are established.

Before the description of the external parameters modeling, the coordinate frames involved in the disclosure are explained as follows.

The sun sensor coordinate frame (marked as Sun) is defined. That is, its X-axis and Y-axis are the row and column of the image sensor respectively, and the Z-axis is vertical to the X-Y plane.

The rotator coordinate frame (Marked as Rot) is defined such that its X′-axis and Y′-axis are the horizontal rotation axis and vertical rotation axis of the rotator on which the sun sensor is installed, and the Z′ axis of Rot is vertical to the X′-Y′ plane.

The sun sensor coordinate frame and rotator coordinate frame defined in the disclosure are both right-hand coordinate (either left-hand coordinate).

Step 102: External parameters modeling

The external parameters that have effect on the calibration precision of the internal parameters of the sun sensor include:

(1) Sunlight vector e from a sun simulator is not strictly vertical to the plane formed by the two rotation axis of the rotator coordinate frame, assuming that the expression of vector e in the rotator coordinate frame is:

$$e = [ \begin{matrix}e 1 \\ e 2 \\ e 3\end{matrix} ] = [ \begin{matrix}cos β cos α \\ cos β sin α \\ sin β\end{matrix} ] \qquad ( 1 )$$

Here, e1, e2, e3 are three direction components of vector e in the coordinate frame Rot, and α, β are pitch and yaw angles in the coordinate frame Rot respectively.

(2) There is installation error between the sun sensor and the rotator which results in the difference of sun sensor coordinate frame Sun and rotator coordinate frame Rot. Assuming that the rotation matrix Rsr denotes the rotation from rotator coordinate frame Rot to sun sensor coordinate frame, Sun is expressed as follows:

Rsr=Rot(Z′, φ1)*Rot(Y′, β1)*Rot(X′, α1) (2)

Here, Rot(X′,α1), Rot(Y′,β1) and Rot(Z′,φ1) are rotation matrixes which denote rotation an angle of α1 about axis X′, rotation an angle of β1 about axis Y′ and rotation an angle of φ1 about axis Z′ respectively- The rotator coordinate frame is transformed to the sun sensor frame coordinate by these rotations. The expressions of these rotations are:

$$Rot ( {Z}^{′} , ϕ 1 ) = [ \begin{matrix}cos ϕ 1 & - sin ϕ 1 & 0 \\ sin ϕ 1 & cos ϕ 1 & 0 \\ 0 & 0 & 1\end{matrix} ] \\ Rot ( {Y}^{′} , β 1 ) = [ \begin{matrix}cos β 1 & 0 & sin β 1 \\ 0 & 1 & 0 \\ - sin β 1 & 0 & cos β 1\end{matrix} ] \\ Rot ( {X}^{′} , α 1 ) = [ \begin{matrix}1 & 0 & 0 \\ 0 & cos α 1 & - sin α 1 \\ 0 & sin α 1 & cos α 1\end{matrix} ] \qquad ( 3 )$$

From above formulas, it can be seen that there are five external parameters, in total, in the calibration system of sun sensor; namely α, β, α1, β1, φ1.

Step 103: Internal parameters modeling

There are errors in the installation of an optical mask of a sun sensor:

(3) The distance between the optical mask and the imaging plane of image sensor is not the ideal value F but the real value of F′.

(4) The point where the pin hole on the optical mask of sun sensor is projected to an image sensor is not the origin of the sun sensor coordinate, and assuming the coordinate of the real projected origin is (x₀, y₀)

Moreover, there is distortion in the pinhole imaging because of the glass base of the optical mask of the sun sensor. Assuming that dx and dy represent the distortion in the x and y direction respectively, the radial distortion coefficients and tangential distortion coefficients are expressed as:

$$\begin{matrix}\{ \begin{matrix}dx = x ( {q}_{1} {r}^{2} + {q}_{2} {r}^{4} + {q}_{3} {r}^{6} ) + \{ {p}_{1} ( {r}^{2} + 2 {x}^{2} ) + 2 {p}_{2} xy \} ( 1 + {p}_{3} {r}^{2} ) \\ dy = y ( {q}_{1} {r}^{2} + {q}_{2} {r}^{4} + {q}_{3} {r}^{6} ) + \{ {p}_{2} ( {r}^{2} + 2 {y}^{2} ) + 2 {p}_{1} xy \} ( 1 + {p}_{3} {r}^{2} )\end{matrix} & ( 4 ) \\ \{ \begin{matrix}x = {x}_{C} - {x}_{0} \\ y = {y}_{C} - {y}_{0} \\ {r}^{2} = {x}^{2} + {y}^{2}\end{matrix} & ( 5 )\end{matrix}$$

Here, x_{c} and y_{c} are the centroid coordinates of a measured spot; x₀ and y₀ are the coordinates of the origin corresponding to the pinhole; q₁, q₂, q₃ are radial distortion coefficients; p₁, p₂, p₃ are tangential distortion coefficients. So, there are a total of nine internal parameters, namely x₀, y₀, F′, q₁, q₂, q₃, p₁, p₂, p₃.

Step 104: Establishing the integrated external and internal parameters imaging model of a sun sensor

The rotator is rotated to acquire different calibration points' data. Assuming that the real rotation angle about the Y′ axis of rotator is θ1 and the rotation angle about the X′ axis of rotator is θ2, the corresponding rotation matrix Rrot can be expressed as:

$$\begin{matrix}Rrot = Rot ( {X}^{′} , θ 2 ) * Rot ( {Y}^{′} , θ 1 ) \\ = [ \begin{matrix}cos θ 1 & 0 & - sin θ 1 \\ 0 & 1 & 0 \\ sin θ 1 & 0 & cos θ 1\end{matrix} ] * [ \begin{matrix}1 & 0 & 0 \\ 0 & cos θ 1 & sin θ 1 \\ 0 & - sin θ 1 & cos θ 1\end{matrix} ]\end{matrix} \qquad ( 6 )$$

According to the external and internal parameters of the calibration system and the real rotation angles of the rotator in the calibration process, the integrated imaging model of sun sensor can be established as following:

$$\begin{matrix}\begin{matrix}V = [ \begin{matrix}f 1 \\ f 2 \\ f 3\end{matrix} ] \\ = Rsr * Rrot * e \\ = Rsr * Rrot * [ \begin{matrix}e 1 \\ e 2 \\ e 3\end{matrix} ]\end{matrix} & ( 7 ) \\ \{ \begin{matrix}{x}_{C} = {F}^{′} * \frac{f 1}{f 3} + {x}_{0} + dx \\ {y}_{C} = {F}^{′} * \frac{f 2}{f 3} + {y}_{0} + dy\end{matrix} & ( 8 )\end{matrix}$$

In the above formula, V is the expression of sunlight vector e in the current sun sensor coordinate frame when the internal and external frames of the rotator are rotated by θ1 and θ2 respectively.

The integrated external and internal parameters imaging model of a sun sensor is obtained by substituting equations (1)-(7) into equation (8). The calibration of sun sensor in the disclosure is to determine the internal parameters (x₀, y₀, F′, q₁, q₂, q₃, p₁, p₂, p₃) and external parameters (α, β, α1, β1, φ1) in the modeling equation according to the calibration points' data.

Step 2: Acquisition of calibration points' data

The two axes of the rotator are rotated by different angles to make sure the imaging spots spread over the whole plane of image sensor with the sunlight within the field of view of ±55° (as shown in FIG. 2). The interface circuit of the sun sensor transfers the centroid coordinates (x₀, y₀) of the maging spot to the processing computer at each rotation position of the rotator. The processing computer records the rotation angle θ1 of the external frame and the rotation angle θ2 of the internal frame simultaneously. When the rotator has rotated for m different positions, m groups of calibration points' data are acquired,

Step 3: Data processing

It can be seen from the model equation that there are a total of 14 calibration parameters in the calibration system. The precision of these parameters are relatively low and the iteration can't easily converge if all 14 parameters are determined by a one-time least square method. Therefore, a two-step method is adopted to calculate the 14 parameters.

Step 301: Determination of the internal parameters x₀ and y₀

Firstly, assume that the distortion coefficients q₁, q₂, q₃, p₁, p₂, p₃ are all equal to zero, so the model equation (8) can be simplified as:

$$\{ \begin{matrix}{x}_{C} = {F}^{′} * \frac{f 1}{f 3} + {x}_{0} = {f}_{x} ( n ) \\ {y}_{C} = {F}^{′} * \frac{f 2}{f 3} + {y}_{0} = {f}_{y} ( n )\end{matrix} \qquad ( 9 )$$

Here, n is a parameter vector which consists of the model parameters [x₀, y₀, F′, α, β, α1, β1, φ1]. Since fₓ and f_{y} are both nonlinear functions, a nonlinear least square iteration method is adopted to estimate the parameter vector n. Assuming that x_{c} and y_{c} are the measured values while \hat{x}_{c} and ŷ_{c} are the estimated values, and Δn is the estimated deviation of the parameter vector, and Δx and Δy are estimated deviation of x_{c} and y_{c} respectively, it gets

$$\{ \begin{matrix}Δ x = {x}_{C} - {\hat{x}}_{C} \approx A Δ n \\ Δ y = {y}_{C} - {\hat{y}}_{C} \approx B Δ n\end{matrix} \qquad ( 10 )$$

Here, A and B are sensitive matrixes, and their expressions are:

$$\{ \begin{matrix}A = [ \begin{matrix}\frac{\partial {f}_{x}}{\partial {x}_{0}} & \frac{\partial {f}_{x}}{\partial {y}_{0}} & \frac{\partial {f}_{x}}{\partial {F}^{′}} & \frac{\partial {f}_{x}}{\partial α} & \frac{\partial {f}_{x}}{\partial β} & \frac{\partial {f}_{x}}{\partial α 1} & \frac{\partial {f}_{x}}{\partial β 1} & \frac{\partial {f}_{x}}{\partial ϕ 1}\end{matrix} ] \\ B = [ \begin{matrix}\frac{\partial {f}_{y}}{\partial {x}_{0}} & \frac{\partial {f}_{y}}{\partial {y}_{0}} & \frac{\partial {f}_{y}}{\partial {F}^{′}} & \frac{\partial {f}_{y}}{\partial α} & \frac{\partial {f}_{y}}{\partial β} & \frac{\partial {f}_{y}}{\partial α 1} & \frac{\partial {f}_{y}}{\partial β 1} & \frac{\partial {f}_{y}}{\partial ϕ 1}\end{matrix} ]\end{matrix} \qquad ( 11 )$$

Assuming that the number of calibration points' data is m, combining the estimated deviation Δx and Δy and the sensitive matrixes, the iteration equation of parameter vector is established as following:

Δn^{(k+1)}=Δn^{(k)}−(Mₖ^{T}Mₖ)⁻¹Mₖ^{T}P^{(k)} (12)

In the above equation, P consists of estimated deviation Δx and Δy, and M consists of two sensitive matrixes A and B. Their expressions are:

$$P = [ \begin{matrix}Δ {x}_{1} \\ ⋮ \\ Δ {x}_{m} \\ Δ {y}_{1} \\ ⋮ \\ Δ {y}_{m}\end{matrix} ] . M = [ \begin{matrix}{A}_{1} \\ ⋮ \\ {A}_{m} \\ {B}_{1} \\ ⋮ \\ {B}_{m}\end{matrix} ]$$

Here, k is iteration times and can be set between 5 and 10. Among the calculated model parameters when iteration ends, only (x₀, y₀) is chosen as the final calibration result to be used in next step to determinate the other parameters.

Step 302: Determination of internal parameters F′, q₁, q₂, q₃, p₁, p₂, p₃ and external parameters

Substituting (x₀, y₀) calculated from the previous step into the model equation (8), and using vector j to denote the model parameters [F′, q₁, q₂, q₃, p₁, p₂, p₃, α, β, α1, β1, φ1], it gets:

$$\{ \begin{matrix}Δ x = {x}_{C} - {\hat{x}}_{C} \approx C Δ j \\ Δ y = {y}_{C} - {\hat{y}}_{C} \approx D Δ j\end{matrix} \qquad$$

Correspondingly the sensitive matrixes C and D change to:

$$\{ \begin{matrix}A = [ \begin{matrix}\frac{\partial {f}_{x}}{\partial {F}^{′}} & \frac{\partial {f}_{x}}{\partial q 1} & \frac{\partial {f}_{x}}{\partial q 2} & \frac{\partial {f}_{x}}{\partial q 3} & \frac{\partial {f}_{x}}{\partial p 1} & \frac{\partial {f}_{x}}{\partial p 2} & \frac{\partial {f}_{x}}{\partial p 3} & \frac{\partial {f}_{x}}{\partial α} & \frac{\partial {f}_{x}}{\partial β} & \frac{\partial {f}_{x}}{\partial α 1} & \frac{\partial {f}_{x}}{\partial β 1} & \frac{\partial {f}_{x}}{\partial ϕ 1}\end{matrix} ] \\ B = [ \begin{matrix}\frac{\partial {f}_{y}}{\partial {F}^{′}} & \frac{\partial {f}_{y}}{\partial q 1} & \frac{\partial {f}_{y}}{\partial q 2} & \frac{\partial {f}_{y}}{\partial q 3} & \frac{\partial {f}_{y}}{\partial p 1} & \frac{\partial {f}_{y}}{\partial p 2} & \frac{\partial {f}_{y}}{\partial p 3} & \frac{\partial {f}_{y}}{\partial α} & \frac{\partial {f}_{y}}{\partial β} & \frac{\partial {f}_{y}}{\partial α 1} & \frac{\partial {f}_{y}}{\partial β 1} & \frac{\partial {f}_{y}}{\partial ϕ 1}\end{matrix} ]\end{matrix} \qquad ( 11 )$$

A same nonlinear least square iteration method is adopted to estimate the parameter vector j, and a similar iteration equation of parameter vector is established:

Δj^{(k+1)=Δ}j^{(k)}−(Nₖ^{T}Nₖ^{T})⁻¹Nₖ^{T}P^{(k)} (13)

In the above equation, N consists of sensitive matrixes C and D, and their expressions are:

$$N = [ \begin{matrix}{C}_{1} \\ ⋮ \\ {C}_{m} \\ {D}_{1} \\ ⋮ \\ {D}_{m}\end{matrix} ]$$

Here, k is iteration times and can be set between 5 and 10. When the iteration ends, the model parameters F′, q₁, q₂, q₃, p₁, p₂, p₃, α, β, α1, β1 and φ1 are determined and chosen as the final calibration result.

Combining (x₀, y₀) determined in the first step and F′, q₁, q₂, q₃, p₁, p₂, p₃, α, β, α1, β1, φ1 determined in the second step, all the calibration parameters in the calibration system are determined

Finally all calibrated internal parameters x₀, y₀, F′, q₁, q₂, q₃, p₁, p₂ and p₃ are substituted into corresponding attitude conversion formulas of the sun sensor, and the precise attitude angle of the sunlight in sun sensor coordinate frame will be calculated. Thereby, the attitude information of the satellites or spacecraft on which the sun sensor is installed is determined.

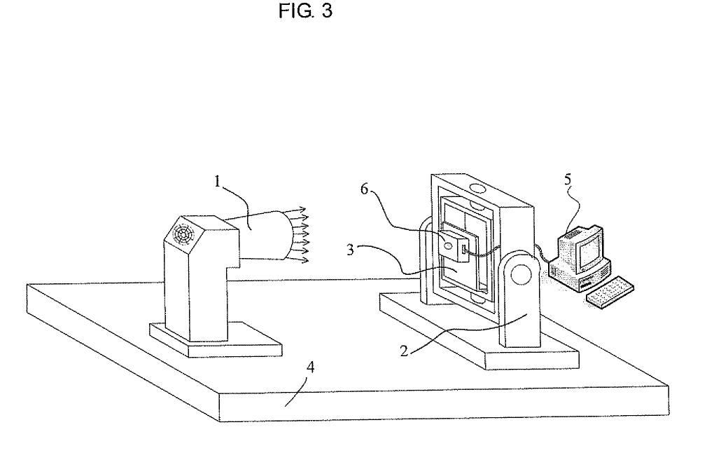

As shown in FIG. 3, the calibration device in the disclosure comprises a sun simulator 1 to provide sunlight, a two-axis rotator 2 with external and internal frames, a bracket 3 to install the sun sensor, an optical platform 4 to uphold the sun simulator 1 and two-axis rotator 2, and a processing computer 5 to perform data acquisition and computing. The sun simulator 1 and two-axis rotator 2 are installed on the each side of the optical platform respectively, and the sun simulator is used to provide needed sunlight.

The processing computer 5 includes a data acquisition module and data processing module. The data acquisition module acquires the calibration points' data which includes the rotating angle θ1 of external frame, the rotating angle θ2 of the internal frame and the centroid coordinate (x_{c}, y_{c}) of the imaging spot at this position. A two-step method and nonlinear least square method are used by the data processing module to determine the final calibration parameters. During the calibration process using the calibration device, the sun sensor 6 is installed on the bracket 3. Different calibration points' data is acquired by rotating the external and internal frame of rotator by different angles. The processing computer 5 records these calibration points' data and calculates the corresponding calibration parameters.

The rotator used in the invention has the precision of ±0.4″ for the external frame and ±0.3″ for the internal frame. The radiation intensity of the sun simulator is 0.1solar constant. The diameter of effective radiation area is 200 mm, and the collimation angle of light beam is 32′.

Totally 84 groups of recorded calibration point's data are listed in Table 1.

TABLE 1
m

| | 1 | 2 | 3 | 4 | 5 | 6 | 7 |
|---|---|---|---|---|---|---|---|
| θ1(°) | 8 | 4 | −4 | −8 | −4 | 4 | 16 |
| θ2(°) | 0 | 7 | 7 | 0 | −7 | −7 | 0 |
| x_{c}(pixel) | 490.5938 | 507.8291 | 543.1906 | 561.3750 | 544.1250 | 508.5344 | 454.1313 |
| y_{c}(pixel) | 518.7813 | 549.8000 | 550.2844 | 519.7188 | 488.4250 | 488.0000 | 518.3125 |

m

| | 8 | 9 | 10 | 11 | 12 | 13 | 14 |
|---|---|---|---|---|---|---|---|
| θ1(°) | 8 | −8 | −16 | −8 | 8 | 25 | 23 |
| θ2(°) | 14 | 14 | 0 | −14 | −14 | 0 | 9 |
| x_{c}(pixel) | 488.9906 | 561.3781 | 598.2000 | 563.4437 | 490.2813 | 410.2156 | 419.0313 |
| y_{c}(pixel) | 580.9938 | 582.0313 | 520.2000 | 456.7437 | 455.8750 | 517.9063 | 557.2813 |

m

| | 15 | 16 | 17 | 18 | 19 | 20 | 21 |
|---|---|---|---|---|---|---|---|
| θ1(°) | 19 | 12 | 4 | −4 | −12 | −19 | −23 |
| θ2(°) | 17 | 22 | 25 | 25 | 22 | 17 | 9 |
| x_{c}(pixel) | 436.1250 | 468.1187 | 505.5250 | 543.6625 | 581.6875 | 614.8469 | 633.0531 |
| y_{c}(pixel) | 593.8063 | 618.4063 | 634.1969 | 634.8125 | 620.2500 | 596.7156 | 560.3156 |

m

| | 22 | 23 | 24 | 25 | 26 | 27 | 28 |
|---|---|---|---|---|---|---|---|
| θ1(°) | −25 | −23 | −19 | −12 | −4 | 4 | 12 |
| θ2(°) | 0 | −9 | −17 | −22 | −25 | −25 | −22 |
| x_{c}(pixel) | 643.1250 | 634.8219 | 617.9156 | 585.3406 | 547.1594 | 508.2531 | 469.8563 |
| y_{c}(pixel) | 520.9688 | 481.0000 | 443.5812 | 418.2250 | 402.0125 | 401.6594 | 417.0469 |

m

| | 29 | 30 | 31 | 32 | 33 | 34 | 35 |
|---|---|---|---|---|---|---|---|
| θ1(°) | 19 | 23 | 35 | 33 | 26 | 17 | 6 |
| θ2(°) | −17 | −9 | 0 | 13 | 24 | 31 | 35 |
| x_{c}(pixel) | 437.0000 | 419.3781 | 354.5000 | 362.7813 | 394.7813 | 437.6250 | 492.9063 |
| y_{c}(pixel) | 441.6469 | 478.4469 | 517.4063 | 574.0000 | 626.4375 | 664.5938 | 689.2500 |

m

| | 36 | 37 | 38 | 39 | 40 | 41 | 42 |
|---|---|---|---|---|---|---|---|
| θ1(°) | −6 | −17 | −26 | −33 | −35 | −33 | −26 |
| θ2(°) | 35 | 31 | 24 | 13 | 0 | −13 | −24 |
| x_{c}(pixel) | 555.3750 | 611.7813 | 656.3750 | 690.6563 | 700.6437 | 693.6906 | 661.6844 |
| y_{c}(pixel) | 690.3750 | 667.5625 | 630.6000 | 578.7875 | 521.9219 | 464.2500 | 409.8344 |

m

| | 43 | 44 | 45 | 46 | 47 | 48 | 49 |
|---|---|---|---|---|---|---|---|
| θ1(°) | −17 | −6 | 6 | 17 | 26 | 33 | 45 |
| θ2(°) | −31 | −35 | −35 | −31 | −24 | −13 | 0 |
| x_{c}(pixel) | 617.9688 | 560.8750 | 496.5656 | 439.3875 | 395.3531 | 362.8438 | 285.8062 |
| y_{c}(pixel) | 369.9438 | 344.2781 | 343.6938 | 368.3125 | 407.1563 | 460.4375 | 516.8438 |

m

| | 50 | 51 | 52 | 53 | 54 | 55 | 56 |
|---|---|---|---|---|---|---|---|
| θ1(°) | 42 | 33 | 21 | 7 | −7 | −21 | −33 |
| θ2(°) | 19 | 33 | 41 | 45 | 45 | 41 | 33 |
| x_{c}(pixel) | 297.7500 | 340.0313 | 402.8937 | 482.1781 | 564.8781 | 645.9562 | 711.8312 |
| y_{c}(pixel) | 599.5625 | 672.4063 | 724.9406 | 756.8063 | 758.4031 | 729.5563 | 678.7188 |

m

| | 57 | 58 | 59 | 60 | 61 | 62 | 63 |
|---|---|---|---|---|---|---|---|
| θ1(°) | −42 | −45 | −42 | −33 | −21 | −7 | 7 |
| θ2(°) | 19 | 0 | −19 | −33 | −41 | −45 | −45 |
| x_{c}(pixel) | 757.7719 | 772.5313 | 763.1094 | 720.9344 | 656.031 | 573.1188 | 486.9376 |
| y_{c}(pixel) | 606.5938 | 523.2250 | 438.1875 | 361.4688 | 305.3438 | 271.6875 | 271.1250 |

m

| | 64 | 65 | 66 | 67 | 68 | 69 | 70 |
|---|---|---|---|---|---|---|---|
| θ1(°) | 21 | 33 | 42 | 55 | 50 | 39 | 24 |
| θ2(°) | −41 | −33 | −19 | 0 | 26 | 43 | 51 |
| x_{c}(pixel) | 404.1875 | 339.4063 | 296.8750 | 192.3687 | 216.7094 | 268.3406 | 360.0000 |
| y_{c}(pixel) | 303.5313 | 358.1250 | 433.1563 | 516.1063 | 630.3469 | 732.7344 | 802.9063 |

m

| | 71 | 72 | 73 | 74 | 75 | 76 | 77 |
|---|---|---|---|---|---|---|---|
| θ1(°) | 8 | −8 | −24 | −39 | −50 | −55 | −50 |
| θ2(°) | 55 | 55 | 51 | 43 | 26 | 0 | −26 |
| x_{c}(pixel) | 466.2719 | 579.3750 | 688.5125 | 785.5000 | 842.8563 | 872.4375 | 851.6000 |
| y_{c}(pixel) | 847.9688 | 850.5031 | 809.8906 | 742.6594 | 640.5406 | 525.0313 | 406.3125 |

m

| | 78 | 79 | 80 | 81 | 82 | 83 | 84 |
|---|---|---|---|---|---|---|---|
| θ1(°) | −39 | −24 | −8 | 8 | 24 | 39 | 50 |
| θ2(°) | −43 | −51 | −55 | −55 | −51 | −43 | −26 |
| x_{c}(pixel) | 801.0313 | 704.8688 | 591.8750 | 471.9031 | 359.5313 | 264.8906 | 214.3094 |
| y_{c}(pixel) | 296.0969 | 219.2594 | 170.4094 | 169.8906 | 217.6375 | 292.5125 | 400.0000 |

The calibration result is obtained by processing the calibration points' data listed in Table 1 using the calibration method described above. The calibration result is listed in Table 2.

TABLE 2

| x₀(pixel) | y₀(pixel) | F′(pixel) | q1 | q2 | q3 | p1 |
|---|---|---|---|---|---|---|
| 523 | 525 | 251 | −7.27e−7 | 3.28e−12 | −7.826e−18 | 4.85e−6 |
| p2 | p3 | α(°) | β(°) | α1(°) | β1(°) | φ1(°) |
| 1.98e−7 | −1.6e−6 | 44.832 | 93.798 | 1.686 | 0.354 | 0.786 |

The total statistical square root error of x_{c} and y_{c} are 5.09 pixel and 4.27 pixel respectively. Substituting the parameters calibrated by the method of the present disclosure into the attitude computing formula of sun sensor, an attitude precision of 0.02 (1σ) is obtained. Because 14 total external and internal parameters are used in the disclosure, theoretically at least 14 groups of calibration data are needed to solve the calibration parameters. Generally, in order to obtain more precise parameters, 50-100 groups of calibration data are acquired. Meanwhile, the calibration points are spread over the field of view of sun sensor as widely as possible. Of course, the more the calibration points are used, the more precise the calibration result are, but at the cost of computing.

The foregoing description of various embodiments of the disclosure has been present for purpose of illustration and description. It is not intent to be exhaustive or to limit the disclosure to the precise embodiments disclosed. Numerous modifications or variations are possible in light of the above teachings. The embodiments discussed where chosen and described to provide the best illustration of the principles of the disclosure and its practical application to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method for calibration of a digital sun sensor comprising the steps of:
A. establishing an integrated mathematic model for imaging of the sun sensor according to the external and internal parameters of the calibration system of the sun sensor;
B. acquiring calibration points' data by rotating a two-axis of rotator by different angles, and then sending the data to a processing computer through an interface circuit; and
C. calculating calibration parameters using a two-step calibration program after substituting the calibration points' data to the integrated mathematic model.

2. The method for calibration of a digital sun sensor as in claim 1, wherein said step A further comprises the steps of:
A1. establishing a rotator coordinate frame and a sun sensor coordinate frame, and establishing an external parameters modeling equation according to a rotation matrix from the rotator coordinate frame to the sun sensor coordinate frame and pitch and yaw angles of an initial vector of simulated sunlight in the rotator coordinate frame;
A2. establishing an internal parameters modeling equation, wherein said internal parameters include: an origin coordinate where a pin hole on an optical mask of the sun sensor is projected to the image sensor, a focal length which equals to the distance between the optical mask and the image sensor, and radial and tangential distortion coefficients of the optical mask; and
A3. establishing an integrated external and internal parameters imaging modeling equation of the sun sensor according to the external parameters modeling equation and the internal parameters modeling equation of the calibration system.

3. The method for calibration of a digital sun sensor as in claim 1, wherein said step C further comprises:
C1. assuming that radial and tangential distortion coefficients of the internal parameters are zero, an origin coordinate where a pin hole is projected to the image sensor is determined by a nonlinear least square iteration;
C2. based on the results from step C1, the rest of the parameters are calculated by a nonlinear least square iteration.

4. The method for calibration of a digital sun sensor as in claim 2, wherein said step C further comprises:
C1. assuming that radial and tangential distortion coefficients of the internal parameters are zero, an origin coordinate where the pin hole is projected to the image sensor is determined by a nonlinear least square iteration;
C2. based on the results from step C1, the rest of the parameters are calculated by a nonlinear least square iteration.

5. A device for calibration of a digital sun sensor comprising: a sun simulator to provide incident sunlight; a two-axis rotator with internal and external frames- a bracket on which the sun sensor is installed; an optical platform to uphold the sun simulator and the two-axis rotator; and a processing computer operatively connected to the sun sensor to perform calibration data acquisition and calculation; said sun simulator and two-axis rotator being installed on the each side of the optical platform respectively; wherein
said processing computer which comprises a data acquisition module and data processing module calculates calibration parameters by a data processing program,
said data acquisition module acquires the calibration points' data which includes the rotating angle of the internal frame of the two-axis rotator, the rotating angle of external frame of the two-axis rotator and the centroid coordinate of an imaging spot at this position;
said data processing module calculating a final calibration parameters based on the calibration points' data acquired above.
